(19) United States
(12) Patent Application Publication
(10) Pub. No.: US 2014/0004222 A1
(43) Pub. Date: Jan. 2, 2014

(54) METHOD FOR THE MANUFACTURE OF A MOULD PART WITH CHANNEL FOR TEMPERATURE REGULATION AND A MOULD PART MADE BY THE METHOD

(71) Applicants: Sven Dalager Sørensen, Tarm (DK); Ole Therkelsen, Billund (DK)

(72) Inventors: Sven Dalager Sørensen, Tarm (DK); Ole Therkelsen, Billund (DK)

(73) Assignee: LEGO A/S, Billund (DK)

(21) Appl. No.: 13/981,291

(22) PCT Filed: Jan. 24, 2012
(86) PCT No.: PCT/DK2012/050029

§ 371 Date: Sep. 23, 2013

(30) Foreign Application Priority Data
Jan. 25, 2011 (DK) PA 2011 70040

(51) Int. Cl. B29C 33/38; B29C 33/02

(52) U.S. Cl. CPC B29C 33/38; B29C 33/02
USPC 425/547; 419/9

(57) ABSTRACT

A mould part for an injection moulding tool, said mould part being configured from sintering metal in a sintering process comprising successive sintering of several layers of sintering metal, whereby the cooling channel and the outer mould of the mould part are formed completely or partially, and wherein the outer shape on the mould part comprises a mould surface configured such that it faces towards the mould cavity; and wherein the mould part further comprises a substantially rectilinear channel extending from the mould surface of the mould part until the cooling channel; and wherein there is configured, in the substantially rectilinear channel, a pin which is configured from a material having a coefficient of thermal conductivity which is higher than the coefficient of the sintering metal.

### FIELD OF APPLICATION OF THE INVENTION

The present invention relates to a method for the manufacture of a mould part for an injection moulding tool, said mould part being configured from powdered sintering metal by successive sintering of multiple layers of sintering metal to the effect that the cooling channel and the outer mould of the mould part are formed completely or partially, and wherein the mould part has an outer mould that comprises a mould surface which is configured such that it faces towards the mould cavity of the injection moulding tool, and a second surface facing away from the mould cavity in the injection moulding tool, and wherein the mould part further comprises at least one cooling channel having at least two openings configured on the second surface of the mould part.

### STATE OF THE ART

Tools for use in injection moulding are known in many configurations, and it is an ongoing challenge to be capable of manufacturing mould tools that provide the option of moulding in particular plastics work pieces of complex geometry, while simultaneously tool costs and the cycle time for the injection moulding process are kept down.

Thus, from eg U.S. Pat. No. 5,753,274 a method for the production of complex work pieces of metal is known, whereby the complex work piece is constructed layer by layer by sintering of many thin layers of sintering metal on top of each other, and whereby the individual layers are heated locally by means of a laser or other influence to the effect that the layer of sintering metal melts where it is desired.

Thus, those methods enable the production of mould parts for injection moulding tools as it is known eg from U.S. Pat. No. 7,261,550.

In particular in the context of very complex geometries, it is thus enabled that the localization of the cooling channels can be optimised, and that machining processing of the mould part is minimised, and hence that the manufacturing costs for the production of mould parts can be minimised, while simultaneously the cycle time of the injection moulding process is minimised.

### OBJECT OF THE INVENTION

Based on this, it is the object of the present invention to provide mould parts for injection moulding tools, whereby those advantages of a sintering process are used to further advantage.

According to the present invention as defined in independent claims 1 and 7, this is accomplished in that it is hereby enabled to use the sintering process also in the context of mould parts having relatively long and thin cores, said mould part further comprising a substantially rectilinear channel extending from the mould surface of the mould part until the cooling channel, and wherein, in the substantially rectilinear channel, a pin is configured which is made of a material having a coefficient of thermal conductivity which is higher than the coefficient of thermal conductivity of the sintering metal, and such that the pin closes the substantially rectilinear channel, and such that at least a portion of the one end of the pin extends into proximity of or into the cooling channel.

In order to provide good thermal conductivity, the substantially rectilinear channel is particularly advantageously configured by a machining process, such as boring out of the mould part.

However, the substantially rectilinear channel may advantageously be completely or partially formed in the same sintering process as the one by which the cooling channel and the mould part exterior are formed to the effect that further machining processing is rendered completely or partially superfluous. However, in this context it is still possible to obtain efficient thermal conductivity if the substantially rectilinear channel formed by the sintering process is further processed by a machining process such as by boring out.

Particularly conveniently, the end of the pin that faces towards the mould surface of the mould part is concealed underneath the mould surface by means of a plug, a screw or other element suitable for that purpose; however, in a preferred embodiment of the invention the mould part is manufactured in that, following mounting of the pin in the substantially rectilinear channel, sintering metal is further added by successive sintering of several layers of sintering metal in such a manner that the substantially rectilinear channel, and hence the pin, is completely enclosed in the mould part.

According to a preferred embodiment, the pin is made of a metal, including copper or aluminium.

Obviously, this method is particularly suitable in the production of mould parts such as core parts that can be mounted in an injection moulding tool; but it is possible, in accordance with the invention, to manufacture complete injection moulding tools.

### LIST OF FIGURES

FIG. 1: is an explanatory sketch in the form of a sectional view showing a mould part according to the invention mounted in an ordinary injection moulding tool.

FIG. 2: is a sectional view showing a first embodiment of a not finished mould part according to the invention, without mounted pin.

FIG. 3: is a sectional view showing the mould part shown in FIG. 2 provided with a pin.

### EMBODIMENT OF THE INVENTION

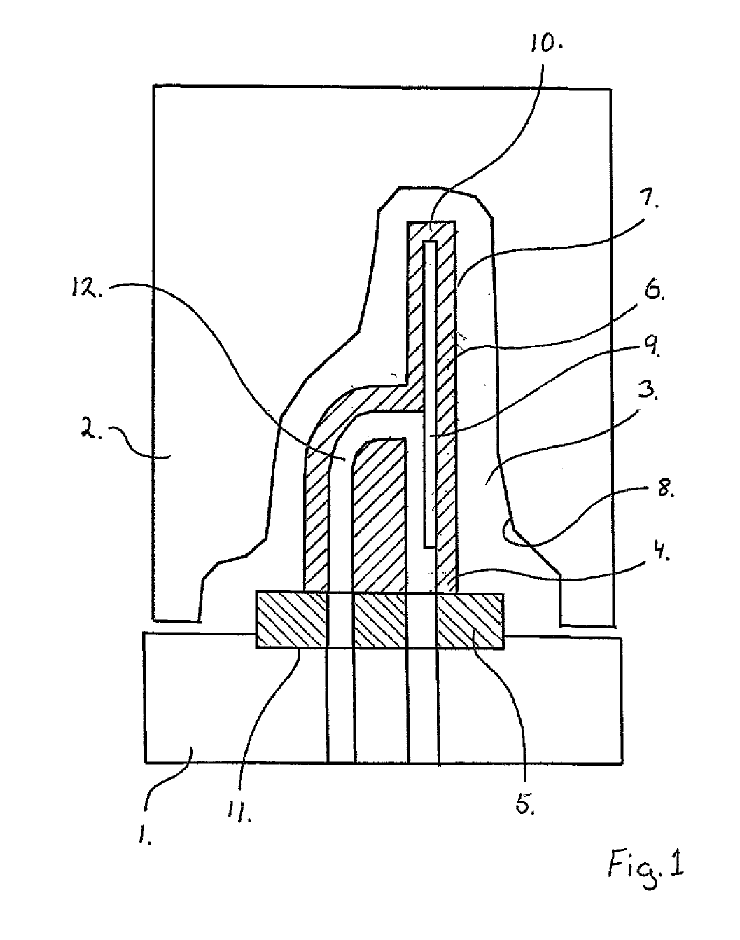

Thus, FIG. 1 shows an explanatory sketch showing an injection moulding tool consisting of two parts 1, 2; and wherein the one part 1 has an interior surface 8 forming a part of the mould cavity 3, and wherein the second part 2 is configured with a mould part 4 forming a core in the injection moulding tool.

The mould part 4 (which is hatched in this figure) comprises a plate-shaped part 5 on which a mould core 6 is built which has been formed by successive sintering of thin layers of a powered sintering metal, such as steel, eg as it is known from the above-mentioned U.S. Pat. No. 5,753,274 and No. 7,261,550.

The plate-shaped part 5 may be configured either from a piece of massive plate material which has been formed eg by a machining process, or it may equally be produced in a sintering process in the same manner as the mould core 6.

Thereby the mould core 7 comprises a mould surface 7 which, along with the interior surface 8 on the one part 1 of the injection moulding process, forms the entire or parts of the mould cavity 3. In addition to the mould surface 7, the mould part 4 also comprises a second surface 11 facing away from the mould cavity 3, and wherein the two openings for the cooling channel 12 are arranged.

In the mould part 4, which comprises the mould core 6 and the plate-shaped part 5, there is provided, as mentioned, a cooling channel 12 for through-flow of a cooling medium, and, in accordance with the invention, a pin 9 is provided that consists of a material having a coefficient of thermal conductivity which is higher than the coefficient of thermal conductivity of the sintering metal that is used for building the mould part 4, the plate-shaped part 5, or the mould core 6.

As will appear from FIG. 1, the pin 9 is completely enclosed in the mould core 6, there being provided a lid 10, at the upper end of the mould core, in close proximity of the mould surface 7, by sintering, to the effect that the lid 10 covers the pin 9 and constitutes a part of the mould surface 7.

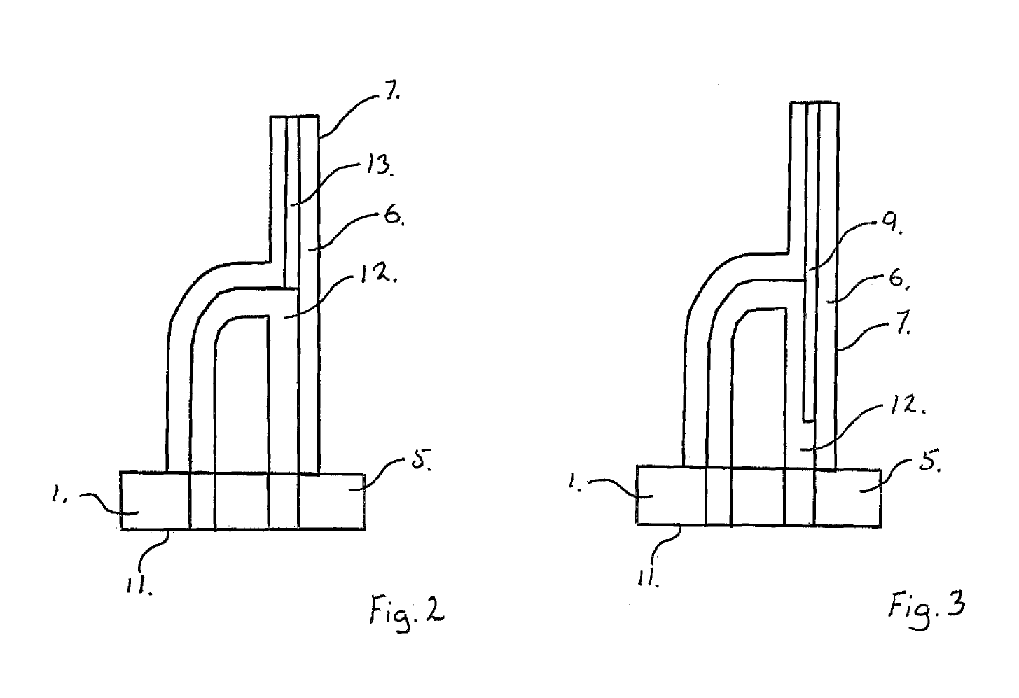

Now, FIGS. 2 and 3 show the mould part 4 which is shown in FIG. 1 after a first and a second production process, FIG. 1 showing the sintered mould core 6 and the plate-shaped part which may also be formed in the sintering process. Here it will appear that, after the first production process, the mould core is provided with a rectilinear channel 13 which may, quite simply, be formed during the sintering process, but which may also possibly be produced by a subsequent boring out of the channel 13 after the mould core 6 has been produced in the sintering process.

Now FIG. 3 shows the same mould core 6 as is shown in FIG. 2, but herein the pin 9 has, however, been inserted such that the one end of the pin 9 is substantially aligned with the mould surface on the mould core 6, following which it may again undergo a further sintering process to the effect that the final mould core 6 ends up being as shown in FIG. 1 where the pin 9 is enclosed in the sintered mould core 6.

Obviously, the present invention may thus be used in connection with mould parts having many different configurations without departing from the fundamental principle of the invention, and, as an example, it may be possible to make mould parts comprising more pins than the one shown in the figures, and the pins 9 may be oriented in different directions from the cooling channel 12 to the effect that it is possible to establish a uniform cooling of the mould part 6 irrespective of the shape of the mould part 6.

1. A method for the manufacture of a mould part for an injection moulding tool, said mould part being configured from sintering metal and having an outer mould that comprises a mould surface which is configured such that it faces towards the mould cavity of the injection moulding tool, and a second surface facing away from the mould cavity in the injection moulding tool, and wherein the mould part further comprises at least one cooling channel having at least two openings configured on the second surface of the mould part; said method comprising the following steps:
a. building of the mould part by successive sintering of several layers of sintering metal to the effect that the cooling channel and the outer mould of the mould part are formed completely or partially;
b. formation of a substantially rectilinear channel extending from the mould surface of the mould part until the cooling channel
c. mounting of a pin in the substantially rectilinear channel, said pin being configured from a material having a coefficient of thermal conductivity which is higher than the coefficient of thermal conductivity of the sintering metal to the effect that the pin closes the substantially rectilinear channel and to the effect that at least a portion of the one end of the pin extends in close proximity of or into the cooling passage.

2. A method according to claim 1, characterised in that the substantially rectilinear passage is configured by a machining process, such as boring out of the mould part.

3. A method according to claim 1, characterised in that the substantially rectilinear channel is completely or partially formed in the same sintering process as the one by which the cooling channel and the mould part exterior are formed.

4. A method according to claim 3, characterised in that the substantially rectilinear channel formed in the sintering process is further processed by a machining process, such as by boring out.

5. A method according to claim 1, characterised in that the mould part is, following mounting of the pin in the substantially rectilinear channel, further supplied with sintering metal by successive sintering of several layers of sintering metal in such a way that a lid of sintering metal is formed across the opening of the substantially rectilinear channel, on the mould surface thereof, and such that the substantially rectilinear channel is enclosed completely in the mould part.

6. A method according to claim 1, characterised in that the pin is made of a metal comprising copper or aluminium.

7. A mould part for an injection moulding tool, said mould part being configured from sintering metal in a sintering process comprising successive sintering of multiple layers of sintering metal to the effect that the cooling channel and the outer mould of the mould part are formed completely or partially, and wherein the outer mould of the mould part comprises a mould surface which is configured such that it faces towards the mould cavity of the injection moulding tool, and a second surface facing away from the mould cavity in the injection moulding tool, and wherein the mould part further comprises at least one cooling channel having at least two openings configured on the second surface of the mould part, characterised in that the mould part further comprises a substantially rectilinear channel extending from the mould surface of the mould part until the cooling channel, and wherein, in the substantially rectilinear channel, a pin is configured which is made of a material having a coefficient of thermal conductivity which is higher than the coefficient of thermal conductivity of the sintering metal, and such that the pin closes the substantially rectilinear channel and such that at least a portion of the one end of the pin extends into proximity of or into the cooling channel.

8. A mould part according to claim 7, characterised in that the pin is configured from a copper- or aluminium-based metal.

9. A mould part according to claim 7, characterised in that the opposite end of the pin, the one facing away from the cooling channel, is completely enclosed in the mould part configured from sintering metal.

10. An injection moulding tool comprising a mould part according to claim 7.

11. A method according to claim 2, characterised in that the mould part is, following mounting of the pin in the substantially rectilinear channel, further supplied with sintering metal by successive sintering of several layers of sintering metal in such a way that a lid of sintering metal is formed across the opening of the substantially rectilinear channel, on the mould surface thereof, and such that the substantially rectilinear channel is enclosed completely in the mould part.

12. A method according to claim 3, characterised in that the mould part is, following mounting of the pin in the substantially rectilinear channel, further supplied with sintering metal by successive sintering of several layers of sintering metal in such a way that a lid of sintering metal is formed across the opening of the substantially rectilinear channel, on the mould surface thereof, and such that the substantially rectilinear channel is enclosed completely in the mould part.

13. A method according to claim 4, characterised in that the mould part is, following mounting of the pin in the substantially rectilinear channel, further supplied with sintering metal by successive sintering of several layers of sintering metal in such a way that a lid of sintering metal is formed across the opening of the substantially rectilinear channel, on the mould surface thereof, and such that the substantially rectilinear channel is enclosed completely in the mould part.

14. A method according to 2, characterised in that the pin is made of a metal comprising copper or aluminium.

15. A method according to 3, characterised in that the pin is made of a metal comprising copper or aluminium.

16. A method according to 4, characterised in that the pin is made of a metal comprising copper or aluminium.

17. A method according to 5, characterised in that the pin is made of a metal comprising copper or aluminium.

18. A mould part according to claim 8, characterised in that the opposite end of the pin, the one facing away from the cooling channel, is completely enclosed in the mould part configured from sintering metal.

19. An injection moulding tool comprising a mould part according to claim 8.

20. An injection moulding tool comprising a mould part according to claim 9.
